(19) United States
(12) Patent Application Publication
(10) Pub. No.: US 2016/0181932 A1
(43) Pub. Date: Jun. 23, 2016

(54) ISOLATED DC/DC CONVERTER, POWER SUPPLY DEVICE, POWER SUPPLY ADAPTOR, AND ELECTRONIC DEVICE USING THE SAME, AND FEEDBACK AMPLIFIER INTEGRATED CIRCUIT

(71) Applicant: ROHM CO., LTD., Ukyo-Ku (JP)

(72) Inventors: Hiroki KIKUCHI, Ukyo-Ku (JP); Manabu OYAMA, Ukyo-Ku (JP); Ryo SHIMIZU, Ukyo-Ku (JP)

(21) Appl. No.: 14/966,423

(22) Filed: Dec. 11, 2015

(30) Foreign Application Priority Data
Dec. 17, 2014 (JP) 2014-255549

(51) Int. Cl. H02M 3/335

(52) U.S. Cl. CPC H02M 3/33507; H02M 3/33592; H02M 3/33553

(57) ABSTRACT

An isolated DC/DC converter includes: a transformer having a primary winding and a secondary winding; a switching transistor connected to the primary winding of the transformer; a rectification element connected to the secondary winding of the transformer; a photo coupler; a feedback amplifier connected to an input side of the photo coupler and configured to generate an error current which increases as an output voltage of the DC/DC converter decreases; a primary side controller having a feedback terminal and configured to switch the switching transistor with a larger duty ratio as a voltage of the feedback terminal becomes higher; and a non-inversion type feedback circuit connected to the output side of the photo coupler and the feedback terminal and configured to increase the voltage of the feedback terminal as a feedback current flowing through the output side of the photo coupler increases.

### CROSS-REFERENCE TO RELATED APPLICATION

This application is based upon and claims the benefit of priority from Japanese Patent Application No. 2014-255549, filed on Dec. 17, 2014, the entire contents of which are incorporated herein by reference.

### TECHNICAL FIELD

The present disclosure relates to a DC/DC converter.

### BACKGROUND

A variety of home appliances such as televisions and refrigerators are operated with commercial AC power supplied from the outside. Electronic devices such as laptop computers, mobile phone terminals and tablet terminals can be also operated with the commercial AC power, or their internal batteries can be charged with the commercial AC power. Such home appliances and electronic devices (hereinafter collectively referred to as electronic devices) contain a power supply device such as an AC/DC converter for converting a commercial AC (alternating current) voltage to a DC (direct current) voltage. Alternatively, in some cases, an AC/DC converter may be incorporated in external power supply adaptors (AC adaptors) of electronic devices.

FIG. 1 is a block diagram illustrating the basic configuration of an AC/DC converter 100r reviewed by the present inventors. The AC/DC converter 100r mainly includes a filter 102, a rectification circuit 104, a smoothing capacitor 106 and a DC/DC converter 200r.

A commercial AC voltage V_{AC} is input to the filter 102 via a fuse and an input capacitor (not shown). The filter 102 removes a noise from the commercial AC voltage V_{AC}. The rectification circuit 104 is a diode bridge circuit for full-wave rectifying the commercial AC voltage V_{AC}. An output voltage of the rectification circuit 104 is converted to a DC voltage V_{IN} by being smoothed by the smoothing capacitor 106.

The isolated DC/DC converter 200r receives the DC voltage V_{IN} input at its input terminal P1 to drop the DC voltage V_{IN} down, and supplies an output voltage V_{OUT}, which is stabilized at a target value, to a load (not shown) connected to its output terminal P2.

The DC/DC converter 200r includes a primary side controller 202, a photo coupler 204, a shunt regulator 206, an output circuit 210 and other circuit components. The output circuit 210 includes a transformer T1, a diode D1, an output capacitor C1 and a switching transistor M1. The topology of the output circuit 210 is the same as that of a typical flyback converter and therefore will not be explained for the sake of brevity.

As the switching transistor M1 connected to the primary winding W1 of the transformer T1 is switched, the input voltage V_{IN} is dropped down to generate the output voltage V_{OUT}. The primary side controller 202 stabilizes the output voltage V_{OUT} at a target value by adjusting a duty ratio of switching of the switching transistor M1.

The output voltage V_{OUT} of the DC/DC converter 200r is divided by resistors R1 and R2. The shunt regulator 206 amplifies an error between the divided voltage (voltage detection signal) Vs and a predetermined reference voltage V_{REF} (not shown), and pulls up an error current I_{ERR} corresponding to the error from a light emitting element (light emitting diode) at the input side of the photo coupler 204 (sink).

A feedback current I_{FB} corresponding to the error current I_{ERR} at a secondary side is flown into a light receiving element (phototransistor) at the output side of the photo coupler 204. The feedback current I_{FB} is smoothed by a resistor and a capacitor and is input to a feedback (FB) terminal of the primary side controller 202. The primary side controller 202 adjusts the duty cycle of the switching transistor M1 based on a voltage (feedback voltage) V_{FB} of the FB terminal.

From a recent demand for energy saving, there is a desire to reduce the power consumption of the AC/DC converter 100r in light load or no-load conditions (also referred to as a waiting state or standby state) as much as possible. To meet this demand, the DC/DC converter 200r is operated in a so-called burst mode (also referred to as a PFM mode) during the standby period. In the burst mode, the primary side controller 202 switches the switching transistor M1 once or more, raises the output voltage V_{OUT} up to the target level, and then stops the switching of the switching transistor M1 until the output voltage V_{OUT} is reduced to a lower limit level determined in accordance with the target level. As such, the power required to switch the switching transistor M1 (for example, power required to charge/discharge the gate capacitance of the switching transistor M1) is reduced, and thereby the efficiency thereof is increased.

The present inventors have reviewed the AC/DC converter 100r of FIG. 1 and have recognized the following problems.

Since the output voltage V_{OUT} is maintained to be higher than the target level for most of the period during which the DC/DC converter 200r is operating in the burst mode, the error current I_{ERR} flowing through the input side of the photo coupler 204 is increased and the current I_{FB} flowing through the output side of the photo coupler 204 is also increased accordingly. These currents I_{ERR} and I_{FB} are a loss which decreases the efficiency of the AC/DC converter 100r.

### SUMMARY

One exemplary objective of the present disclosure is to provide some embodiments of a DC/DC converter which is capable of reducing power consumption during the standby period.

According to one embodiment of the present disclosure, there is provided an isolated DC/DC converter including: a transformer having a primary winding and a secondary winding; a switching transistor connected to the primary winding of the transformer; a rectification element connected to the secondary winding of the transformer; a photo coupler; a feedback amplifier connected to the input side of the photo coupler and configured to generate an error current which increases as an output voltage of the DC/DC converter decreases; a primary side controller having a feedback terminal and configured to switch the switching transistor with a larger duty ratio as a voltage of the feedback terminal becomes higher; and a non-inversion type feedback circuit connected to the output side of the photo coupler and the feedback terminal and configured to raise the voltage of the feedback terminal as a feedback current flowing through the output side of the photo coupler increases.

According to this embodiment, it is possible to reduce the currents respectively flowing through the input and output sides of the photo coupler in the standby state (light or no load conditions) operating in the burst mode, and thereby increase the efficiency.

The non-inversion type feedback circuit may include a resistor positioned between the feedback terminal and a ground. The photo coupler may be connected to the feedback terminal such that the photo coupler sources the feedback current.

The rectification element may include a synchronous rectification transistor. The DC/DC converter may further include a synchronous rectification controller which controls the synchronous rectification transistor.

The DC/DC converter may be of a flyback type or a forward type.

According to another embodiment of the present disclosure, there is provided a power supply (AC/DC converter) including: a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter configured to drop down the DC input voltage and supply the dropped-down voltage to a load.

According to another embodiment of the present disclosure, there is provided an electronic device including: a load; a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter configured to drop down the DC input voltage and supply the dropped-down voltage to the load.

According to another embodiment of the present disclosure, there is provided an AC adaptor including: a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter configured to drop down the DC input voltage to generate a DC output voltage.

According to another embodiment of the present disclosure, there is provided a feedback amplifier integrated circuit disposed at the secondary side of an isolated DC/DC converter. The isolated DC/DC converter includes: a transformer having a primary winding and a secondary winding; a switching transistor connected to the primary winding of the transformer; a rectification element connected to the secondary winding of the transformer; a photo coupler; a primary side controller which has a feedback terminal and switches the switching transistor with a duty ratio corresponding to a voltage of the feedback terminal; a non-inversion type feedback circuit which is connected to the feedback terminal and configured to raise the voltage of the feedback terminal as a feedback current flowing through the output side of the photo coupler increases; and the feedback amplifier integrated circuit. The feedback amplifier integrated circuit includes: an output terminal connected to the input side of the photo coupler; an input terminal which receives a detection signal corresponding to an output voltage of the DC/DC converter; a ground terminal; a reference voltage source which generates a reference voltage; a differential amplifier having a non-inverted input terminal to which the detection signal is input, and an inverted input terminal to which the reference voltage is input; and an output transistor having a control terminal connected to an output of the differential amplifier, a first terminal connected to the output terminal, and a second terminal connected to the ground terminal. The feedback amplifier integrated circuit is packaged into a single module.

Any combinations of the above-described elements or any modifications to the representations of the present disclosure between methods, apparatuses and systems are effective as embodiments of the present disclosure.

### BRIEF DESCRIPTION OF THE DRAWINGS

FIG. 1 is a block diagram illustrating the basic configuration of an AC/DC converter reviewed by the present inventors.

FIG. 2 is a circuit diagram of an AC/DC converter according to a first embodiment.

FIGS. 3A and 3B are circuit diagrams illustrating exemplary configurations of a non-inversion type feedback circuit.

FIG. 4 is a circuit diagram of an AC/DC converter according to a second embodiment.

FIGS. 5A to 5C are circuit diagrams illustrating exemplary configurations of a primary side controller.

FIG. 6 is a diagram illustrating an AC adaptor including an AC/DC converter.

FIGS. 7A and 7B are diagrams illustrating an electronic device including an AC/DC converter.

### DETAILED DESCRIPTION

Preferred embodiments of the present invention will now be described in detail with reference to the drawings. Throughout the drawings, the same or similar elements, members and processes are denoted by the same reference numerals and explanation of which may not be repeated. The disclosed embodiments are provided for the purpose of illustration, not limitation, of the present disclosure and all features and combinations thereof described in the embodiments cannot be necessarily construed to describe the substance of the present disclosure.

In the specification, the phrase “connection of a member A and a member B” is intended to include direct physical connection of the member A and the member B as well as indirect connection thereof via other member as long as the other member has no substantial effect on the electrical connection of the member A and the member B. Similarly, the phrase “interposition of a member C between a member A and a member B” is intended to include direct connection of the member A and the member C or direct connection of the member B and the member C as well as indirect connection thereof via other member as long as the other member has no substantial effect on the electrical connection of the member A, the member B and the member C.

### First Embodiment

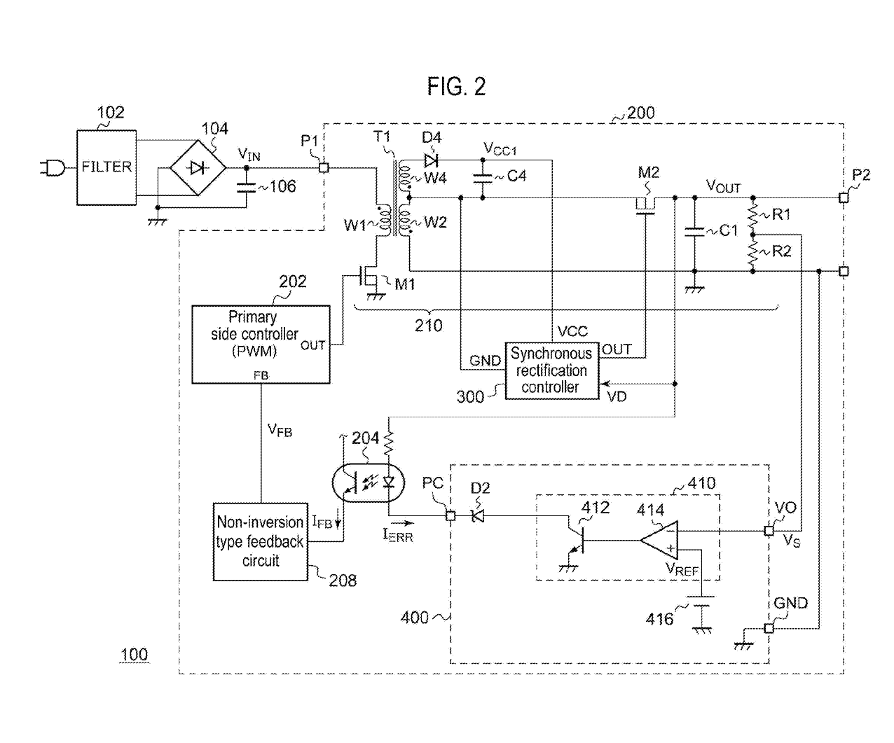

FIG. 2 is a block diagram of an AC/DC converter 100 according to a first embodiment. The AC/DC converter 100 includes a filter 102, a rectification circuit 104 and an isolated DC/DC converter 200.

The isolated DC/DC converter 200 includes a primary side controller 202, a photo coupler 204, an output circuit 210, a non-inversion type feedback circuit 208, a synchronous rectification controller 300 and a feedback amplifier IC (Integrated Circuit) 400. The output circuit 210 has a flyback synchronous rectification type topology and includes transformer T1, a switching transistor M1, a synchronous rectification transistor M2 and an output capacitor C1. In this embodiment, the synchronous rectification transistor M2 is placed at a side with higher potential (output terminal P2 side) than a secondary winding W2 of the transformer T1.

A circuit consisting of an auxiliary winding W4 of the transformer T1, a diode D4 and a capacitor C4 generates an external power supply voltage V_{CC1} based on the source of the synchronous rectification transistor M2. The synchronous rectification controller 300 is placed at the secondary side of the DC/DC converter 200 and switches the synchronous rectification transistor M2. The external power supply voltage V_{CC1} is supplied to a power supply (VCC) terminal of the synchronous rectification controller 300. A ground (GND) terminal of the synchronous rectification controller 300 is connected with the source of the synchronous rectification transistor M2. A drain voltage VD of the synchronous rectification transistor M2 is input to a VD terminal of the synchronous rectification controller 300. The gate of the synchronous rectification transistor M2 is connected to an OUT terminal thereof. The synchronous rectification transistor M2 may be embedded in the synchronous rectification controller 300.

The control scheme of the synchronous rectification transistor M2 by the synchronous rectification controller 300 is not particularly limited. For example, the synchronous rectification controller 300 may generate a pulse signal at least based on a voltage across the synchronous rectification transistor M2, i.e., a voltage V_{DS} between a drain and a source, and may switch the synchronous rectification transistor M2 based on the pulse signal.

More specifically, the synchronous rectification controller 300 can generate the pulse signal based on the voltage V_{DS} between the drain and a source and two negative threshold voltages V_{TH1} and V_{TH2} (V_{TH1}<V_{TH2}<0V). For example, V_{TH1} may be −50 mV and V_{TH2} may be −10 mV. If the drain-source voltage V_{DS} is lower than the first negative threshold voltage V_{TH1}, the synchronous rectification controller 300 sets the pulse signal to a level that instructs to turn on the synchronous rectification transistor M2 (ON level, e.g., high level), and then sets the pulse signal to a level that instructs to turn off the synchronous rectification transistor M2 (OFF level, e.g., low level) if the drain-source voltage V_{DS} is higher than the second negative threshold voltage V_{TH2}. A drive circuit drives the synchronous rectification transistor M2 based on the pulse signal generated as discussed above.

The feedback amplifier IC (Integrated Circuit) 400 is placed at the secondary side of the DC/DC converter 200, generates an error current I_{ERR} in response to an output voltage V_{OUT}, and supplies it to the primary side controller 202 via the photo coupler 204. The feedback amplifier IC 400 includes an error amplifier 410, a diode D2 and a reference voltage source 416, and is packaged into a single module.

A voltage detection signal V_{S} corresponding to the output voltage V_{OUT} is input to a VO terminal of the feedback amplifier IC 400. A GND terminal thereof is connected to a ground line at the secondary side of the transformer T1. A cathode of a light emitting element (light emitting diode) at the input side of the photo coupler 204 is connected to a photo coupler connection (PC) terminal.

The reference voltage source 416 generates a reference voltage V_{REF}. The error amplifier 410 amplifies an error between the voltage detection signal V_{S} corresponding to the output voltage V_{OUT} of the DC/DC converter 200 and the target voltage V_{REF}, and draws the error current I_{ERR} corresponding to the error from the photo coupler 204 via the PC terminal (sink).

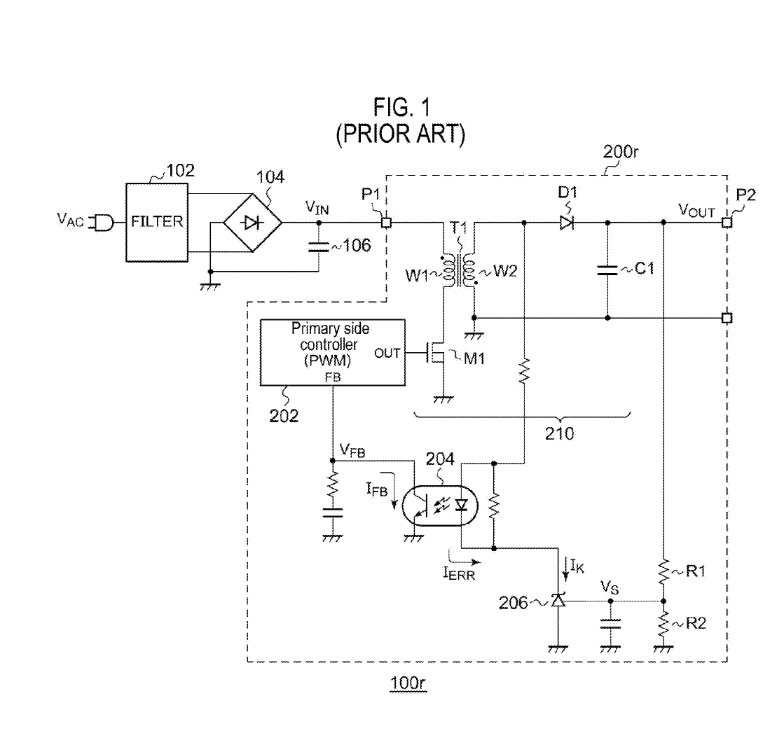

In this embodiment, the feedback amplifier IC 400 increases the error current I_{ERR} as the output voltage V_{OUT} of the DC/DC converter 200 decreases, i.e., as the voltage detection signal V_{S} decreases. That is, it performs the operation opposite to the shunt regulator 206 of the AC/DC converter 100r shown in FIG. 1.

The error amplifier 410 has an output stage of an open collector or open drain type, and includes an output transistor 412 and a differential amplifier 414. The differential amplifier 414 receives the voltage detection signal V_{S} at its inverted input terminal (−) and the reference voltage V_{REF} at its non-inverted input terminal (+). The collector (or drain) of the transistor 412 at the output stage is connected to the PC terminal, and the emitter (or source) thereof is connected to the GND terminal. A control terminal (base or gate) of the output transistor 412 is connected to an output of the differential amplifier 414. A base current or gate voltage of the transistor 412 is adjusted by the output of the differential amplifier 414 corresponding to the error between the voltage detection signal V_{S} and the reference voltage V_{REF}. With this configuration, the error current I_{ERR} flowing through the output transistor 412 decreases as the voltage detection signal V_{S} becomes higher.

Although it is illustrated in this embodiment where the diode D2 is placed between the collector of the transistor 412 and the PC terminal for the purpose of circuit protection or voltage level shift, the diode D2 may be omitted in other embodiments.

The shunt regulator 206 shown in FIG. 1 may be regarded as a non-inverted polarity trans-conductance amplifier (V/I converter), whereas the feedback amplifier IC 400 shown in FIG. 2 may be regarded as an inverted polarity trans-conductance amplifier when viewed as a whole.

The primary side controller 202 has a feedback (FB) terminal, and switches the switching transistor M1 with a larger duty ratio as a voltage V_{FB} of the FB terminal becomes higher. The primary side controller 202 may be implemented with techniques commonly known in the art and the configuration thereof is not particularly limited.

The non-inversion type feedback circuit 208 is connected to the output side of the photo coupler 204 and the FB terminal of the primary side controller 202. The non-inversion type feedback circuit 208 raises the voltage V_{FB} of the FB terminal as the feedback current I_{FB} flowing through the output side of the photo coupler 204 increases.

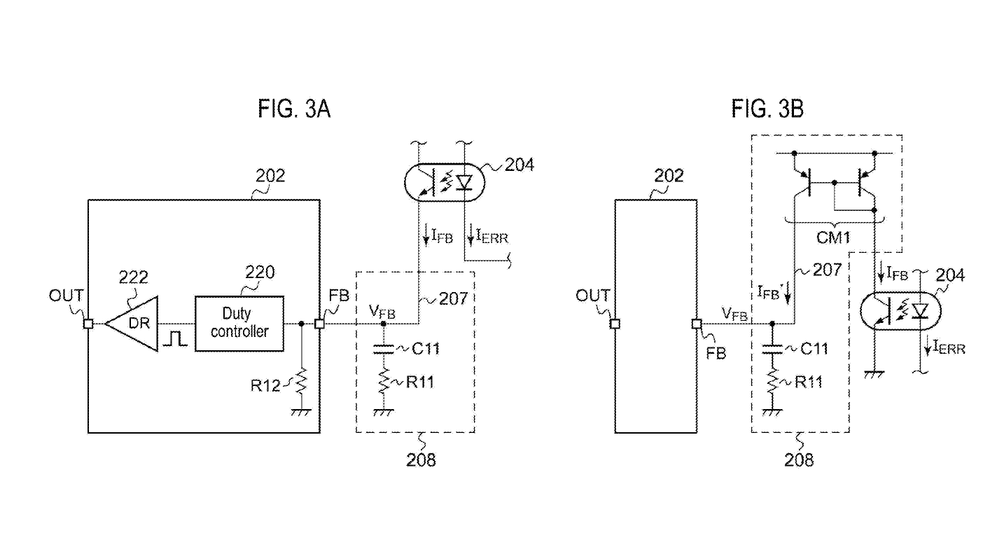

FIGS. 3A and 3B are circuit diagrams illustrating exemplary configurations of the non-inversion type feedback circuit 208. The non-inversion type feedback circuit 208 shown in FIG. 3A includes a feedback resistor R11, a capacitor C11 and a signal line 207. The feedback resistor R11 and the capacitor C11 are placed in series between the FB terminal of the primary side controller 202 and the ground. The signal line 207 is connected between the FB terminal and the emitter of a phototransistor at the output side of the photo coupler 204.

When the feedback current I_{FB} flowing through the output side of the photo coupler 204 increases, the capacitor C11 is charged, the voltage drop of the feedback resistor R11 increases and the feedback voltage V_{FB} increases accordingly.

The primary side controller 202 includes a duty controller 220 and a driver 222. The duty controller 220 generates a pulse signal S_{PWM} having a duty ratio corresponding to the feedback voltage V_{FB}. The duty controller 220 may be constituted by, but is not limited to, a voltage mode or current mode modulator. The duty controller 220 is configured to be operated in a burst mode under no-load or light load conditions where a load current of the DC/DC converter 200 is substantially zero or very small. The driver 222 switches the switching transistor M1 based on the pulse signal S_{PWM}. The primary side controller 202 may include a resistor R12 for discharging charges of the capacitor C11. Alternatively, the resistor R12 may be externally attached to the primary side controller 202 and may be a part of the non-inversion type feedback circuit 208.

The non-inversion type feedback circuit 208 shown in FIG. 3B includes a current mirror circuit CM1 in addition to the non-inversion type feedback circuit 208 shown in FIG. 3A. An input of the current mirror circuit CM1 is connected with the collector of the phototransistor of the photo coupler 204 and an output thereof is connected with the feedback resistor R11 via the signal line 207. The feedback current I_{FB} flowing through the output side of the photo coupler 204 is copied by the current mirror circuit CM1 and an output current I_{FB}′ of the current mirror circuit CM1 generates a voltage drop V_{FB} at the feedback resistor R11.

It should be understood by those skilled in the art that any configurations of the non-inversion type feedback circuit 208 other than the circuit illustrated herein can be implemented to perform the same function.

The configuration of the DC/DC converter 200 has been described above. Subsequently, the operations thereof will be described.

When the voltage detection signal V_{S} becomes higher than the reference voltage V_{REF}, the current I_{ERR} drawn by the output transistor 412 decreases and the current I_{FB} of the light receiving element (phototransistor) at the output side of the photo coupler 204 decreases accordingly. At this time, since the feedback voltage V_{FB} is reduced by the non-inversion type feedback circuit 208, the duty ratio (ON time) of the switching transistor M1 is reduced and a feedback is applied in such a way that the voltage detection signal V_{S} approaches (i.e., is reduced) to the reference voltage V_{REF}.

Conversely, when the voltage detection signal V_{S} becomes lower than the reference voltage V_{REF,} the current I_{ERR} drawn by the output transistor 412 increases and the current I_{FB} of the light receiving element increases accordingly. Since the feedback voltage V_{FB} increases at this time, the duty ratio of the switching transistor M1 is increased and a feedback is applied in such a way that the voltage detection signal V_{S} approaches (i.e., is increased) to the reference voltage V_{REF}. In this way, the output voltage V_{OUT} of the DC/DC converter 200 is stabilized at its target level.

As described above, when the DC/DC converter 200 is in the light load or no load conditions, the primary side controller 202 operates in the burst mode. In the burst mode, the switching transistor M1 is turned on once or more to increase the output voltage V_{OUT}, and then, the output capacitor C1 is discharged by a small load current or a leak current and the switching is stopped until the output voltage V_{OUT} is reduced to the target level.

In other words, in the standby period during which the DC/DC converter 200 operates in the burst mode, the output voltage V_{OUT} is maintained to be relatively higher than that in the normal switching operation. In the DC/DC converter 200 shown in FIG. 2, when the output voltage V_{OUT} increases in the standby period, the error current I_{ERR} flowing through the input side of the photo coupler 204 decreases and the feedback current I_{FB} of the output side of the photo coupler 204 also decreases accordingly.

Specifically, in cases where the DC/DC converter 200r shown in FIG. 1 uses the shunt regulator 206 as commercially available, the error current I_{ERR} during the standby period is several hundred micro A, which is wasted at both of the input and output sides of the photo coupler 204 during the standby period. In contrast, according to the DC/DC converter 200 shown in FIG. 2, the error current I_{ERR} during the standby period can be reduced to substantially zero or several ten micro A.

Therefore, it is possible to significantly reduce the power consumption of the DC/DC converter 200 during the standby period as compared to that in FIG. 1, thereby increasing the efficiency thereof. In particular, in power supply adaptors and other many electronic devices, since the DC/DC converter 200 is on standby with no load conditions for a long period of time, it has an advantage to increase the efficiency during the standby period.

### Second Embodiment

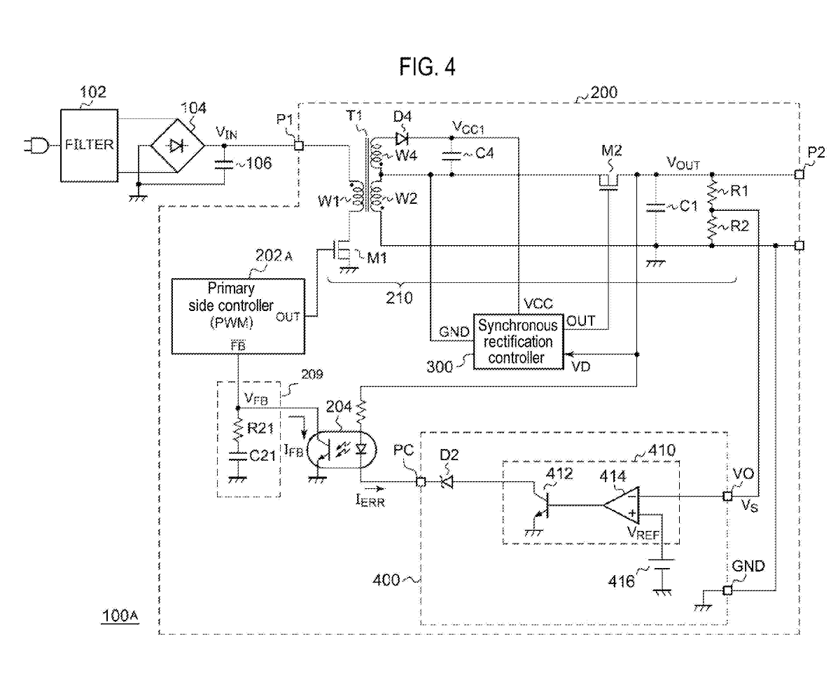

FIG. 4 is a block diagram of an AC/DC converter 100A according to a second embodiment. The AC/DC converter 100A includes a filter 102, a rectification circuit 104 and an isolated DC/DC converter 200A.

The DC/DC converter 200A will be described such that the descriptions mainly focus on its differences from the DC/DC converter 200 shown in FIG. 2.

The isolated DC/DC converter 200A includes an inversion type primary side controller 202A, a photo coupler 204, an output circuit 210, a synchronous rectification controller 300 and a feedback amplifier IC 400.

The feedback amplifier IC 400 generates an error current I_{ERR} corresponding to an output voltage V_{OUT} and supplies it to the primary side controller 202A via the photo coupler 204, in the same manner as shown in FIG. 2. In the second embodiment, as in the first embodiment, the feedback amplifier IC 400 increases the error current I_{ERR} as the output voltage V_{OUT} of the DC/DC converter 200 decreases, i.e., as the voltage detection signal V_{S} decreases. That is, the feedback amplifier IC 400 performs the operation opposite to the shunt regulator 206 of the AC/DC converter 100r shown in FIG. 1. The feedback amplifier IC 400 may have the same configuration as that in the first embodiment.

The feedback current I_{FB} flowing through a phototransistor of the photo coupler 204 is converted to a feedback voltage V_{FB} by an inversion type feedback circuit 209. The inversion type feedback circuit 209 may have, for example, the same configuration as that in FIG. 1 and includes a resistor R21 and a capacitor C21 for phase compensation.

A FB# terminal of the primary side controller 202A has the opposite polarity to the FB terminal of the primary side controller 202 shown in FIGS. 1 and 2. The symbol “#” given to signals and terminals in the specification and the bar in the drawing indicate an inversion. The primary side controller 202A switches the switching transistor M1 with a larger duty ratio as a voltage V_{FB} of the FB terminal becomes lower.

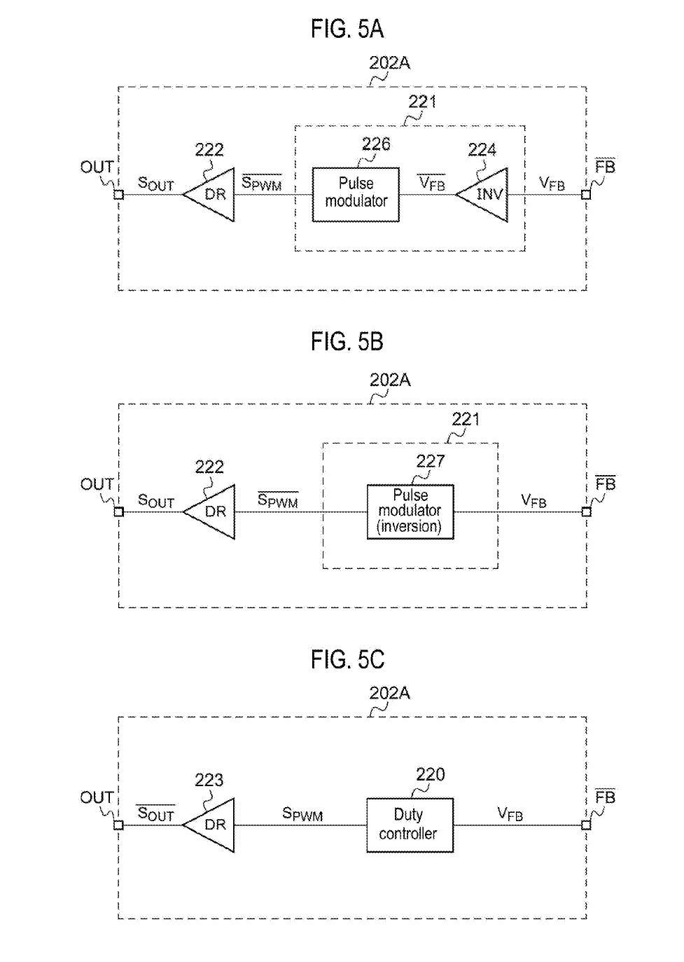

FIGS. 5A to 5C are circuit diagrams showing exemplary configurations of the primary side controller 202A. The primary side controller 202A shown in FIGS. 5A and 5B includes an inversion type duty controller 221 and a driver 222.

The inversion type duty controller 221 generates a pulse signal S_{PWM}# with a larger time ratio of low level as the feedback voltage V_{FB} becomes higher. The driver 222 drives the switching transistor M1 based on the pulse signal S_{PWM}#.

The inversion type duty controller 221 shown in FIG. 5A includes an inversion amplifier 224 and a pulse modulator 226. The inversion amplifier 224 inverts and amplifies the voltage V_{FB} of the FB terminal. The pulse modulator 226 generates the pulse signal S_{PWM}# based on a voltage V_{FB}# of the inversion amplifier 224. The time ratio of a high level of the pulse signal S_{PWM}# is adjusted to become larger as the voltage V_{FB}# of the inversion amplifier 224 becomes higher.

The inversion type duty controller 221 shown in FIG. 5B includes an inversion type pulse modulator 227. The inversion type pulse modulator 227 generates a pulse signal S_{PWM}# based on the feedback voltage V_{FB}. The time ratio of a high level of the pulse signal S_{PWM}# is adjusted to become smaller as the feedback voltage V_{FB} becomes higher.

The primary side controller 202A shown in FIG. 5C includes a duty controller 220 and an inversion type driver 223. The duty controller 220 generates a pulse signal S_{PWM} with a larger time ratio of a high level as the feedback voltage V_{FB} becomes higher. The inversion type driver 223 drives the switching transistor M1 based on an inverted signal S_{OUT}# of the pulse signal S_{PWM}.

It should be understood by those skilled in the art that any configurations of the inversion type primary side controller 202A other than the circuit illustrated herein can be implemented to perform the same function.

The configuration of the DC/DC converter 200A has been described as above. The DC/DC converter 200A as above, as in the first embodiment, may significantly reduce the power consumption of the DC/DC converter 200A during the standby period as compared to that of FIG. 1, thereby further increasing the efficiency thereof.

### (Use)

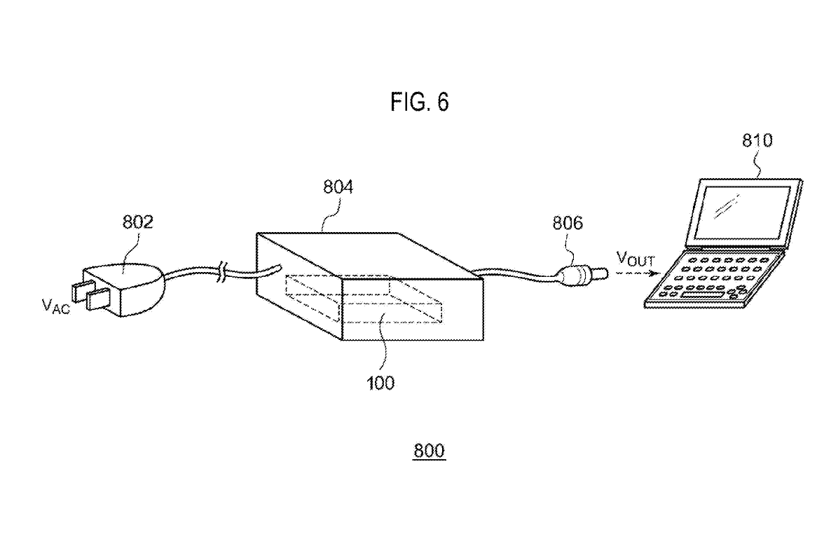

Subsequently, the use of the DC/DC converter 200 described in the first or second embodiment will be described. FIG. 6 is a diagram illustrating an AC adaptor 800 including the AC/DC converter 100. The AC adaptor 800 includes a plug 802, a housing 804 and a connector 806. The plug 802 receives a commercial AC voltage V_{AC} from an electrical outlet (not shown). The AC/DC converter 100 is embedded in the housing 804. A DC output voltage V_{OUT} generated by the AC/DC converter 100 is supplied to an electronic device 810 from the connector 806. Examples of the electronic device 810 may include a laptop PC, a digital camera, a digital video camera, a mobile phone, a portable audio player and the like.

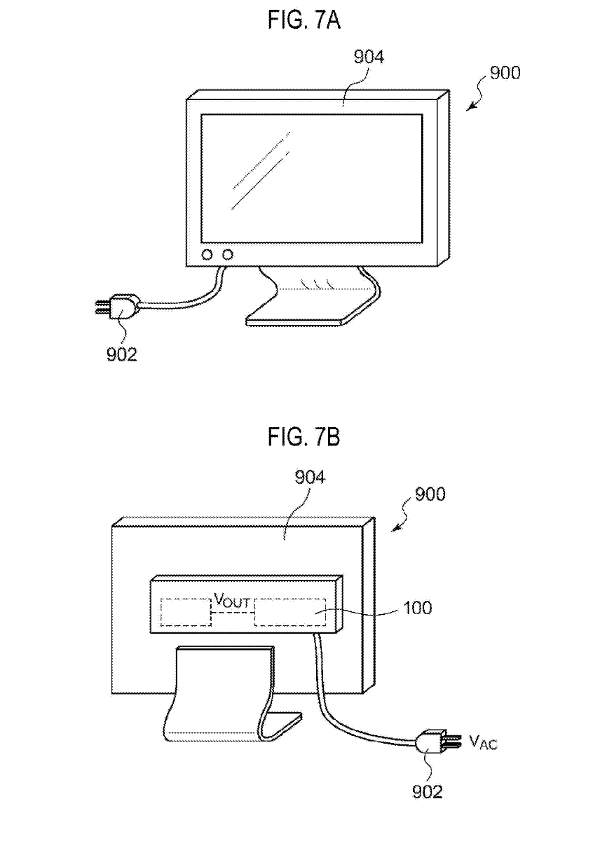

FIGS. 7A and 7B are diagrams illustrating an electronic device 900 including the AC/DC converter 100. Although the electronic device 900 shown in FIGS. 7A and 7B is a display device, the type of the electronic device 900 is not particularly limited. For example, the electronic device may be an audio system, a refrigerator, a washing machine, a vacuum cleaner or other electronic devices containing a power supply. A plug 902 receives a commercial AC voltage V_{AC} from an electrical outlet (not shown). The AC/DC converter 100 is embedded in a housing 904. A DC output voltage V_{OUT} generated by the AC/DC converter 100 is supplied to a load such as a microcomputer, a DSP (Digital Signal Processor), a power supply circuit, lighting device, an analog circuit, a digital circuit or the like, which is mounted in the housing 904.

The present disclosure describes some embodiments as above. The disclosed embodiments are exemplary, and thus, it should be understood by those skilled in the art that various modifications to combinations of the elements or processes above may be made and such modifications will also fall within the scope of the present disclosure. Some exemplary modifications will be described below.

### (First Modification)

The synchronous rectification transistor M2 may be provided at the ground side rather than the secondary winding W2. In this case, the power supply voltage of the synchronous rectification controller 300 may be taken from the output voltage V_{OUT} and the ground voltage thereof may be the ground voltage of the DC/DC converter 200. Further, in this case, the synchronous rectification transistor M2 may be incorporated in the synchronous rectification controller 300

### (Second Modification)

Although the DC/DC converter 200 of the synchronous rectification type has been described in the above embodiments, the present disclosure is not limited thereto but may be applied to a diode rectification type DC/DC converter 200 as well.

### (Third Modification)

The synchronous rectification controller 300 and the feedback amplifier IC 400 may be modularized into a single package.

### (Fourth Modification)

Although the flyback converter has been described in the above embodiments, the present disclosure may be applied to a forward converter as well. In this case, a plurality of synchronous rectification transistors is disposed at the secondary side of the transformer T1. In the synchronous rectification controller, the drive circuit 302, which is configured to switch the plurality of synchronous rectification transistors, and the error amplifier 410 are modularized into a single package. Alternatively, a plurality of synchronous rectification controllers shown in FIGS. 2, 4 and 5 may be used to conform to the forward converter. Further, the converter may be of a pseudo-resonance type.

### (Fifth Modification)

At least one of the switching transistor and the synchronous rectification transistor may be a bipolar transistor or an IGBT.

According to some embodiments of the present disclosure, it is possible to provide a DC/DC converter which is capable of reducing power consumption during a standby period.

While certain embodiments have been described using specific languages, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An isolated DC/DC converter comprising:
a transformer having a primary winding and a secondary winding;
a switching transistor connected to the primary winding of the transformer;
a rectification element connected to the secondary winding of the transformer;
a photo coupler;
a feedback amplifier connected to an input side of the photo coupler and configured to generate an error current which increases as an output voltage of the DC/DC converter decreases;
a primary side controller having a feedback terminal and configured to switch the switching transistor with a larger duty ratio as a voltage of the feedback terminal becomes higher; and
an non-inversion type feedback circuit connected to an output side of the photo coupler and the feedback terminal and configured to increase the voltage of the feedback terminal as a feedback current flowing through the output side of the photo coupler increases.

2. The isolated DC/DC converter of claim 1, wherein the non-inversion type feedback circuit includes a resistor placed between the feedback terminal and a ground, and
wherein the photo coupler is connected to the feedback terminal such that the photo coupler sources the feedback current.

3. The isolated DC/DC converter of claim 1, wherein the non-inversion type feedback circuit includes a capacitor placed between the feedback terminal and a ground, and
wherein the photo coupler is connected to the feedback terminal such that the photo coupler sources the feedback current.

4. The isolated DC/DC converter of claim 1, wherein the feedback amplifier includes:
a reference voltage source which generates a reference voltage;
a differential amplifier having a non-inverted input terminal, to which a detection signal corresponding to the output voltage of the DC/DC converter is input, and an inverted input terminal to which the reference voltage is input; and
an output transistor having a control terminal connected to an output of the differential amplifier, a first terminal connected to the input side of the photo coupler, and a second terminal connected to a ground terminal.

5. The isolated DC/DC converter of claim 1, wherein the rectification element includes a synchronous rectification transistor, and the isolated DC/DC converter further comprises a synchronous rectification controller which controls the synchronous rectification transistor.

6. The isolated DC/DC converter of claim 1, wherein the isolated DC/DC converter is of a flyback type.

7. The isolated DC/DC converter of claim 1, wherein the isolated DC/DC converter is of a forward type.

8. A power supply comprising:
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
DC/DC converter of claim 1, which is configured to drop down the DC input voltage and supply the dropped-down voltage to a load.

9. An electronic device comprising:
a load;
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
DC/DC converter of claim 1, which is configured to drop down the DC input voltage and supply the dropped-down DC input voltage to a load.

10. A power supply adaptor comprising:
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
DC/DC converter of claim 1, which is configured to drop down the DC input voltage and supply the dropped-down voltage to a load.

11. A feedback amplifier integrated circuit disposed at a secondary side of an isolated DC/DC converter, wherein the isolated DC/DC converter includes:
a transformer having a primary winding and a secondary winding;
a switching transistor connected to the primary winding of the transformer;
a rectification element connected to the secondary winding of the transformer;
a photo coupler;
a primary side controller which has a feedback terminal and switches the switching transistor with a duty ratio corresponding to a voltage of the feedback terminal;
a non-inversion type feedback circuit which is connected to the feedback terminal and configured to increase the voltage of the feedback terminal as a feedback current flowing through an output side of the photo coupler increases; and
the feedback amplifier integrated circuit,
wherein the feedback amplifier integrated circuit comprises:
an output terminal connected to an input side of the photo coupler;
an input terminal which receives a detection signal corresponding to an output voltage of the DC/DC converter;
a ground terminal;
a reference voltage source which generates a reference voltage;
a differential amplifier having a non-inverted input terminal, to which the detection signal is input, and an inverted input terminal to which the reference voltage is input; and
an output transistor having a control terminal connected to an output of the differential amplifier, a first terminal connected to the output terminal, and a second terminal connected to the ground terminal, and
wherein the feedback amplifier integrated circuit is packaged into a single module.
